(19) United States
(12) Patent Application Publication
(10) Pub. No.: US 2025/0224990 A1
(43) Pub. Date: Jul. 10, 2025

(54) RESOURCE SCHEDULING METHOD AND APPARATUS THEREOF

(71) Applicant: Lenovo (Beijing) Limited, Beijing (CN)

(72) Inventors: Xudong ZHANG, Beijing (CN); Zongfu QU, Beijing (CN); Cong LI, Beijing (CN)

(21) Appl. No.: 19/008,307

(22) Filed: Jan. 2, 2025

(30) Foreign Application Priority Data
Jan. 9, 2024 (CN) 202410034289.2

(51) Int. Cl. G06F 9/50; G06F 9/48

(52) U.S. Cl. CPC G06F 9/5038; G06F 9/4881

(57) ABSTRACT

A resource scheduling method is provided in the present disclosure. The resource scheduling method includes determining a scheduling mode corresponding to a system at least according to dynamic running information of a target application in the system, where the dynamic running information of the target application at least includes one of running information and resource utilization information of the target application; and the scheduling mode characterizes a utilization strategy of a target model for multiple types of resources in the system; and further include based on the scheduling mode, adjusting utilization of at least one type of resource in the system by at least one target model running in the system, such that a corresponding type of resource needed to run the target application is adjusted.

### CROSS-REFERENCE TO RELATED APPLICATION

This application claims the priority of Chinese Patent Application No. 202410034289.2, filed on Jan. 9, 2024, the content of which is incorporated herein by reference in its entirety.

### TECHNICAL FIELD

The present disclosure generally relates to the field of resource scheduling technology, and, more particularly, relates to a resource scheduling method and a resource scheduling apparatus.

### BACKGROUND

When a large model application is running in a system, the large model application may utilize a large amount of system memory, video memory or other related computing resources. When other applications are running on the system that uses the large model, other applications may run abnormally or inefficiently due to unreasonable resource allocation.

### SUMMARY

One aspect of the present disclosure provides a resource scheduling method. The method includes determining a scheduling mode corresponding to a system at least according to dynamic running information of a target application in the system, where the dynamic running information of the target application at least includes one of running information and resource utilization information of the target application; and the scheduling mode characterizes a utilization strategy of a target model for multiple types of resources in the system; and further include based on the scheduling mode, adjusting utilization of at least one type of resource in the system by at least one target model running in the system, such that a corresponding type of resource needed to run the target application is adjusted.

Another aspect of the present disclosure provides a computing system. The computing system includes a memory, configured to store a computer program; one or more processors, configured to, when the computer program is executed, perform a resource scheduling method. The method includes determining a scheduling mode corresponding to a system at least according to dynamic running information of a target application in the system, where the dynamic running information of the target application at least includes one of running information and resource utilization information of the target application; and the scheduling mode characterizes a utilization strategy of a target model for multiple types of resources in the system; and further include based on the scheduling mode, adjusting utilization of at least one type of resource in the system by at least one target model running in the system, such that a corresponding type of resource needed to run the target application is adjusted.

Another aspect of the present disclosure provides a non-transitory computer-readable storage medium, containing a computer program for, when executed by at least one processor, performing a resource scheduling method. The method includes determining a scheduling mode corresponding to a system at least according to dynamic running information of a target application in the system, where the dynamic running information of the target application at least includes one of running information and resource utilization information of the target application; and the scheduling mode characterizes a utilization strategy of a target model for multiple types of resources in the system; and further include based on the scheduling mode, adjusting utilization of at least one type of resource in the system by at least one target model running in the system, such that a corresponding type of resource needed to run the target application is adjusted.

Other aspects of the present disclosure may be understood by those skilled in the art in light of the description, the claims, and the drawings of the present disclosure.

### BRIEF DESCRIPTION OF THE DRAWINGS

To clearly describe the technical solutions of various embodiments of the present disclosure, the drawings need to be used for describing various embodiments are described below. Obviously, the drawings in the following description are merely some embodiments of the present disclosure. For those skilled in the art, other drawings may be obtained in accordance with these drawings without creative efforts.

FIG. 1 illustrates a flowchart of a resource scheduling method according to various embodiments of the present disclosure.

FIG. 2 illustrates another flowchart of a resource scheduling method according to various embodiments of the present disclosure.

FIG. 3 illustrates another flowchart of a resource scheduling method according to various embodiments of the present disclosure.

FIG. 4 illustrates a resource scheduling schematic according to various embodiments of the present disclosure.

FIG. 5 illustrates a structural schematic of a resource scheduling apparatus according to various embodiments of the present disclosure.

FIG. 6 illustrates a schematic of a resource scheduling apparatus according to various embodiments of the present disclosure.

### DETAILED DESCRIPTION

The technical solutions in embodiments of the present disclosure are clearly and completely described below with reference to the accompanying drawings in embodiments of the present disclosure. Obviously, described embodiments are only a part of embodiments of the present disclosure, but not all embodiments. Based on embodiments in the present disclosure, all other embodiments obtained by those skilled in the art without creative efforts shall fall within the protection scope of the present disclosure.

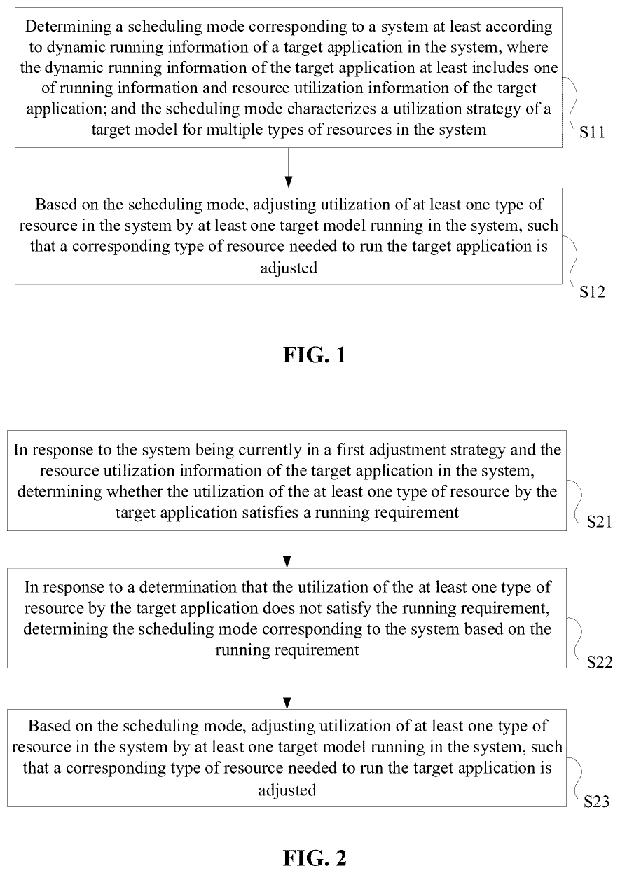

The present disclosure provides a resource scheduling method. FIG. 1 illustrates a flowchart of a resource scheduling method according to various embodiments of the present disclosure. Referring to FIG. 1, the resource scheduling method may include the following exemplary steps.

At S11, a scheduling mode corresponding to a system, e.g., a computing system, may be determined at least according to dynamic running information (obtained) of a target application in the system. The dynamic running information of the target application may at least include one of the running information and the resource utilization information of the target application. The scheduling mode may characterize a utilization strategy of a target model for multiple types of resources in the system.

At S12, based on the scheduling mode, utilization of at least one type of resource in the system by at least one target model running in the system may be adjusted, such that a corresponding type of resource needed to run the target application may be adjusted.

When a model application is running in the system, in response to the model application utilizing relatively large amount of system resources during the running process, the model application may cause other applications or functions in the system to fail to operate normally due to insufficient resources. For example, during the running process of a model application in the system, in response to that a video conferencing application and a 3D modeling application are started in the system, the model application may utilize relatively large amount of system resources during the running process. Therefore, during the running process of the video conferencing application or the 3D modeling application, the resources of the system used for the video conferencing or 3D modeling may not match resources actually needed, which may result in inability of above-mentioned applications to be desirably performed.

Based on the above, in the solution provided in the present disclosure, the scheduling mode corresponding to the system may be determined at least according to one of the running information and resource utilization information of the target application in the system (that is, certain other applications with priority); and utilization of at least one type of resource in the system by at least one target model running in the system may be adjusted based on corresponding scheduling mode, which may ensure the use of corresponding type of resource needed to run the target application in the system, and avoid the problem of abnormal running or inefficiency of the target application.

The dynamic running information of the target application in the system may be obtained, where the target application may be at least an application in running state. The target application may be an application in running state with certain priority in the system. The dynamic running information of the target application may include at least one of the running information and resource utilization information of the target application. The running information of the target application may be the information of the start or stop of the target application. The resource utilization information of the target application may be relevant information of the resources actually utilized by the target application during the running process, for example, utilization of different processors, memory capacity, power consumption and the like. Taking utilization of different processors as an example, the target application may run in the system and currently utilize 30% of the resource of the central processing unit CPU and 20% of the resource of the graphics processing unit GPU.

After obtaining the dynamic running information of the target application in the system, the scheduling mode corresponding to the system may be determined based on obtained dynamic running information of the target application in the system. That is, the dynamic running information of different target applications in the system may determine different scheduling modes, which may be convenient to adjust utilization of at least one type of resource in the system by at least one target model running in the system based on determined scheduling mode, thereby ensuring normal running of the target application in the system and avoiding abnormal running or inefficiency of the target application due to uneven utilization of system resources. The target model may be a large model application running in the system, which may also be called a foundation model. The large model may be a model with hundreds of millions of parameters generated by learning data such as hundreds of millions of corpora, images or the like.

For example, the target application may need to use relatively large amount of the first-type resource, such that the target model in determined scheduling mode should reduce utilization of the first-type resource; and the target application may need to use relatively small amount of the second-type resource, the target model in determined scheduling mode may accordingly increase utilization of the second-type resource.

The scheduling mode may be configured to characterize the utilization strategy of the target model for multiple types of resources in the system; that is, for different scheduling modes, the target model may utilize different types of resources in the system, where the target model may be one or more. Taking one target model as an example, exemplarily, in the first scheduling mode, the first target model may utilize 40% of the first type resources and 30% of the second type resources; and in the second scheduling mode, the first target model may utilize 20% of the first type resources and 40% of the second type resources and/or the like.

Furthermore, it should be noted that the scheduling mode may schedule the resource utilization of the target model in the running state. That is after obtaining the dynamic running information of the target application in the system, corresponding scheduling mode may be determined according to the target model in the running state in the system, thereby scheduling utilization of the target model in the running state for multiple types of resources in the system.

Based on the scheduling mode, utilization of at least one type of resource in the system by at least one target model running in the system may be adjusted. The scheduling mode may include the utilization data of each type of resource in the system by each target model in the running state, and the resource utilization of the target model in the running state may be adjusted according to the scheduling mode.

For example, in current running system, the first target model may utilize 20% of the first-type resource, 50% of the second-type resource, and 30% of the third-type resource. Based on the scheduling mode, the resource utilization of the first target model may be adjusted to be that the first target model may utilize 40% of the first-type resource, 40% of the second-type resource, and 20% of the third-type resource.

After utilization of at least one type of resource in the system by at least one target model running in the system is adjusted based on the scheduling mode, the target application running in the system may run based on current resources of the system.

Utilization of at least one type of resource in the system by at least one target model may be adjusted based on the scheduling mode; that is, the utilization information of at least one type of resource needed to run at least one target model may be actually determined based on the scheduling mode, and utilization of at least one type of resource by at least one target model may be adjusted based on the utilization information.

The utilization information may include whether at least one type of resource is utilized and the size of resource utilization. Before determining the scheduling mode and adjusting utilization of at least one type of resource in the system by the target model based on the scheduling mode, the target model may be in the running state and utilize at least one type of resource. For example, the target model may utilize the first-type resource and the second-type resource. After determining the scheduling mode, the target model may determine utilization of different types of resources based on the scheduling mode. Exemplarily, whether the target model needs to utilize the first-type resource may be determined; and in response to that the first-type resource needs to be utilized, the utilization size of the first-type resource may be determined. Whether the target model needs to utilize the second-type resource may be determined; and in response to that the second-type resource needs to be utilized, the utilization size of the second-type resource may be determined. In response to that the system also includes other types of resources, it may continue to determine whether the target model needs to utilize the third-type resource. Furthermore, in response to that the third-type resource needs to be utilized, the utilization size of the third-type resource may be determined, until determining that the target model needs to utilize all types of resources in the system.

After determining the utilization information, utilization of at least one type of resource by the target model may be adjusted based on the utilization information. For example, before the adjustment based on the scheduling mode, the target model may utilize 40% of the first-type resource and 30% of the second-type resource. Based on the dynamic running information of the target application, it may determine that the target model needs to reduce utilization of the first-type resource, and corresponding scheduling mode may be determined. In addition, the utilization information may be determined based on the scheduling mode. The utilization information may be that the target model needs to utilize 20% of the first-type resource, 40% of the second-type resource, and 10% of the third-type resource, which may reduce utilization of the first-type resource while ensuring normal running of the target model, thereby being convenient for the target application to increase utilization of the first-type resource.

Or, before the adjustment based on the scheduling mode, the target model may utilize 40% of the first-type resource and 30% of the second-type resource. Based on the dynamic running information of the target application, it may determine that the target model needs to reduce utilization of the first-type resource, and corresponding scheduling mode may be determined. In addition, the utilization information may be determined based on the scheduling mode. The utilization information may be that the target model needs to utilize 50% of the second-type resource and 30% of the third-type resource; that is, the target model may no longer utilize the first-type resource. In order to ensure normal running of the target model, the target model may increase utilization of the third-type resource.

For example, before the adjustment based on the scheduling mode, the data processing of the target model may be performed on the graphics processor GPU. Since the running of the target application needs the graphics processor GPU, the data processing of the target model may be transferred to the central processing unit CPU as a whole and no longer performed on the graphics processor GPU, instead of directly exiting the target model to free up the graphics processor GPU for the target application to be performed on the graphics processor GPU. That is, when the resource utilization of the target model is adjusted based on the scheduling mode, in response to utilization of a certain type of resource by the target model needs to be reduced, the problem of insufficient utilization of a certain type of resource may be compensated by increasing utilization of other types of resources by the target model, such that the target model may always be kept running without directly exiting the target model.

For the resource scheduling method provided in the present disclosure, the scheduling mode corresponding to the system may be determined at least according to obtained dynamic running information of the target application in the system, where the dynamic running information of the target application may at least include one of the running information and the resource utilization information of the target application, and the scheduling mode may characterize the utilization strategy of the target model for multiple types of resources in the system; and based on the scheduling mode, utilization of at least one type of resource in the system by at least one target model running in the system may be adjusted, such that corresponding type of resource needed to run the target application may be adjusted. For the solution provided in the present disclosure, the scheduling mode corresponding to the system may be determined at least according to obtained running information or resource utilization information of the target application in the system and may adjust utilization of at least one type of resource in the system by the target model based on corresponding scheduling mode. Therefore, adjustment of corresponding type of resource needed to run the target application may be realized, which may avoid abnormal running or inefficiency of the target application due to the target model excessively utilizing corresponding type of resource needed to run the target application.

A resource scheduling method is provided in one embodiment. The flowchart of the resource scheduling method is illustrated in FIG. 2. The resource scheduling method may include following exemplary steps.

At S21, in response to the system being currently in the first adjustment strategy and obtained resource utilization information of the target application in the system, whether utilization of at least one type of resource by the target application satisfies the running requirement may be determined.

At S22, in response to determining that utilization of at least one type of resource by the target application does not satisfy the running requirement, the scheduling mode corresponding to the system may be determined based on the running requirement.

At S23, based on the scheduling mode, utilization of at least one type of resource in the system by at least one target model running in the system may be adjusted, such that corresponding type of resource needed to run the target application may be adjusted.

The system may be in different adjustment strategies, and different manners may be configured to determine the scheduling modes for different adjustment strategies, such that utilization of at least one type of resource in the system by at least one target model running in the system may be adjusted based on the scheduling mode.

In response to the system being currently in the first adjustment strategy, the scheduling mode may be determined based on the first manner. The first manner may be that, in response to obtaining the resource utilization information of the target application in the system, whether utilization of at least one type of resource by the target application satisfies the running requirement may be determined; and in response to determining that the running requirement is not satisfied, the scheduling mode corresponding to the system may be determined based on the running requirement.

That is, in response to the system being in the first adjustment strategy, the resource utilization information of the target application may need to be obtained, and whether utilization of at least one type of resource by the target application satisfies the running requirement may be determined based on the resource utilization information of the target application, such that whether the scheduling mode needs to be adjusted may be determined.

For example, while the target application in the system is running, the running requirement of the target application may be satisfied only when utilization of the first-type resource reaches 30%. In response to determining that utilization of the first-type resource is 25% based on obtained resource utilization information of the target application, it may determine that utilization of the first-type resource by the target application may not satisfy the running requirement; and in response to determining that utilization of the first-type resource is 35% based on obtained resource utilization information of the target application, it may determine that utilization of the first-type resource by the target application may satisfy the running requirement.

When determining that utilization of at least one type of resource by the target application does not satisfy the running requirement (for example when determining that utilization of the first-type resource by the target application does not satisfy the running requirement, and the running requirement is that utilization of the first-type resource by the target application reaches 30%), the scheduling mode may be determined based on that utilization of the first-type resource by the target application needs to reach 30%. Therefore, after adjusting utilization of at least one type of resource by at least one target model in the system based on the scheduling mode, utilization of the first-type resource by the target application may reach 30%. For example, based on determined scheduling mode, utilization of the first-type resource by at least one target model may be reduced, and utilization of other types of resources by at least one target model may be increased, such that on the basis of ensuring normal running of at least one target model, the idle first-type resource in the system may be increased, and the target model may increase utilization of the first-type resource.

In response to determining that utilization of each type of resource by the target application satisfies the running requirement, it may determine that the target application is in normal running state at this point, and there may be no abnormal running or inefficiency due to insufficient utilized resources. At this point, current scheduling mode of the system may not be adjusted.

It should be noted that in response to multiple target applications that utilization of at least one type of resource does not satisfy the running requirement, it may need to determine corresponding scheduling mode based on the running requirement of multiple target applications.

In addition, the second adjustment strategy may be also included in one embodiment. In response to the system being currently in the second adjustment strategy and obtained running information of the target application in the system, the scheduling mode in the historical record corresponding to the target application may be determined; the scheduling mode in the historical record corresponding to the target application may be determined as the scheduling mode corresponding to the system.

That is, in response to the system being in the second adjustment strategy, as long as the running information of the target application startup is obtained, the scheduling mode corresponding to the target application may be determined, and utilization of at least one type of resource in the system by at least one target model running in the system may be adjusted based on the scheduling mode.

By obtaining the running information of the target application, it may determine that the target application is in the running state. As long as determining that the target application is in the running state, the scheduling mode may be adjusted to the scheduling mode corresponding to the target application. The scheduling mode corresponding to the target application may be determined based on the historical record. The historical record may be learned in advance to determine the utilization rule of at least one type of resource in the system when each application has different running information, thereby determining corresponding scheduling mode when each application has different running information. Therefore, when the running information of each target application is determined, corresponding scheduling mode may be adjusted in time, such that adjustment of the scheduling mode may be realized in advance before the target application runs out of resources and smooth running of the target application may be ensured.

For the solution provided in the present disclosure, current adjustment strategy may be determined, such that the scheduling mode may be determined in different manners based on different adjustment strategies; and resource scheduling may be performed based on determined scheduling mode. Therefore, adjustment of corresponding type of resource needed to run the target application may be realized, which may avoid abnormal running or inefficiency of the target application due to the target model excessively utilizing corresponding type of resource needed to run the target application.

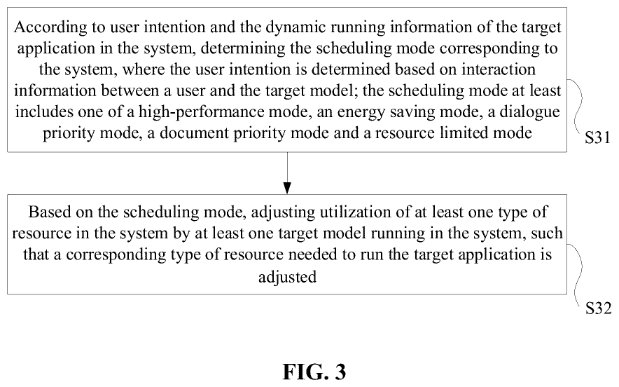

A resource scheduling method is provided in one embodiment. The flowchart of the resource scheduling method is illustrated in FIG. 3. The resource scheduling method may include following exemplary steps.

At S31, according to obtained dynamic running information of the target application in the system and the user intention, the scheduling mode corresponding to the system may be determined. The user intention may be determined based on the interaction information between the user and the target model. The scheduling mode may at least include one of a high-performance mode, an energy saving mode, a dialogue priority mode, a document priority mode and a resource limited mode.

At S32, based on the scheduling mode, utilization of at least one type of resource in the system by at least one target model running in the system may be adjusted, such that a corresponding type of resource needed to run the target application may be adjusted.

The running state information of the target application in the system may be obtained and analyzed. In response to determining that utilization of at least one type of resource by the target application does not satisfy the running requirement, utilization of at least one type of resource in the system by the target model may need to be adjusted at this point; that is, the scheduling mode may need to be adjusted, and utilization of at least one type of resource in the system by the target model may be adjusted based on the scheduling mode.

In an optional implementation manner, the scheduling mode may be determined based on user intention. That is, under different user intentions, when determining that utilization of at least one type of resource by the target application does not satisfy the running requirement, the scheduling mode may be different. User intention may be execution operations that the user wants to perform when the user interacts with the target model. The user may interact with the target model to generate interaction information. For example, through the target model, the user may click submit button, enter content, perform minimization, or upload document, or the like. The system may determine that the user has performed operations such as submission or input based on the target model; that is, the interaction information may be determined. The system may analyze the interaction information to determine the user intention. For example, in response to that the user performs the document upload operation through the target model, it may determine that the user needs to upload document based on above-mentioned operation, which may be determined as the user intention.

The types of user intentions may at least include dialogue intention, document operation intention, and no intention.

For example, in response to the user intention being the dialogue intention and determination that utilization of at least one type of resource by the target application does not satisfy the running requirement, the scheduling mode corresponding to the system may be at least determined to be the high-performance mode, the dialogue priority mode, or the resource limited mode; in response to the user intention being the document operation intention and determination that utilization of at least one type of resource by the target application does not satisfy the running requirement, the scheduling mode corresponding to the system may be at least determined to be the document priority mode, the resource limited mode, or the energy saving mode; and in response to the user intention being no intention and determination that utilization of at least one type of resource by the target application does not satisfy the running requirement, the scheduling mode corresponding to the system may be at least determined to be the energy saving mode.

The scheduling mode may at least include one of the high-performance mode, the energy saving mode, the dialogue priority mode, the document priority mode and the resource limited mode.

Utilization of at least one type of resource in the system by the target model in the high-performance mode may be greater than utilization of at least one type of resource in the system by the target model in in dialogue priority mode; utilization of at least one type of resource in the system by the target model in the in dialogue priority mode may be greater than utilization of at least one type of resource in the system by the target model in the document priority mode; utilization of at least one type of resource in the system by the target model in the in document priority mode may be greater than utilization of at least one type of resource in the system by the target model in the energy saving mode; and in the resource limited mode, utilization of at least one type of resource in the system by the target model may depend on limiting parameters.

Under different user intentions, utilization of at least one type of resource in the system by the target model may be different.

In response to the user intention being the dialogue intention and determination that utilization of at least one type of resource by the target application does not satisfy the running requirement, it may need to reduce utilization of at least one type of resource needed for the target application to run in the system by the target model while ensuring that the dialogue intention is executed smoothly. In such way, it may ensure that the dialogue intention is executed smoothly, and the scheduling mode may be determined to be the high-performance mode, the dialogue priority mode, or the resource limited mode.

In response to the user intention being the dialogue intention and the system being currently in the high-performance mode, utilization of at least one type of resource by the target application may not satisfy the running requirement. Therefore, in order to ensure smooth completion of the dialogue intention and utilization of resources by the target application, the scheduling mode may be adjusted from the high-performance mode to the dialogue priority mode to reduce utilization of at least one type of resource in the system by the target model. Or in response to the system being currently in the dialogue priority mode, the scheduling mode may be adjusted from the dialogue priority mode to the resource limited mode to reduce utilization of at least one type of resource in the system by the target model. Or in response to the system being currently in the high-performance mode, utilization of the first-type resource by the target application may not satisfy the running requirement. Meanwhile the target model in the high-performance mode may not utilize the first-type resource; or utilized first-type resource may be only used to complete the dialogue intention, and the completion of the dialogue intention by the first-type resource cannot be replaced by other types of resources. At this point, the target model may be maintained in the high-performance mode, and utilization of at least one type of resources in the system by other target models may be adjusted.

In response to the user intention being the document operation intention, at this point, it may determine that utilization of at least one type of resource by the target application does not satisfy the running requirement. In order to ensure smooth completion of the document operation intention and utilization of resources by the target application, the scheduling mode may be adjusted from the high-performance mode to the document priority mode, the resource limited mode or the resource limited mode; and the scheduling mode may be adjusted from the document priority mode to the resource limited mode or the resource limited mode. In response to current mode being the document priority mode, the document priority mode may also be maintained to be unchanged.

In response to the user intention being no intention, it may determine that utilization of at least one type of resource by the target application does not satisfy the running requirement. Since the user intention is no intention, the scheduling mode may be directly determined as the resource limited mode, which may avoid utilization of resources by the target model.

It should be further noted that during the running process of the target mode, the scheduling mode of the target model may also be determined during the initial stage for the user to start various functions of the target model or during the stage that utilization of at least one type of resource by the target application does not satisfy the running requirement.

For example, in response to the user intention being no intention after the target model is started, the target model may only need to utilize relatively small amount of system resources at this point, and the scheduling mode may be determined as the energy saving mode. Furthermore, in response to that utilization of at least one type of resource by the target application does not satisfy the running requirement, the energy saving mode may be maintained or stopped.

For another example, in response to that the target model enters the energy saving mode after being started, the user may further perform document classification, that is, the user intention may be the document operation intention. Therefore, the scheduling mode may be adjusted to the document priority mode or the high-performance mode based on the document operation intention. Furthermore, when detecting that utilization of at least one type of resource by the target application does not satisfy the running requirement, the scheduling mode may be re-determined. The scheduling mode may be determined as the resource limited mode or the document priority mode. As such, utilization of at least one type of resource in the system by the target model may be adjusted to free up at least one type of resource needed to run the target application.

For another example, in response to that the target model enters the energy saving mode after being started and the user further interacts with the model, that is, the user intention is the dialogue intention, the scheduling mode may be directly determined as the dialogue priority mode or the high-performance mode based on the dialogue intention. Furthermore, when detecting that utilization of at least one type of resource by the target application does not satisfy the running requirement, the scheduling mode may be re-determined. The scheduling mode may be determined as the resource limited mode or the dialogue priority mode or may be maintained in the high-performance mode. As such, utilization of at least one type of resource in the system by the target model may be adjusted to free up at least one type of resource needed to run the target application.

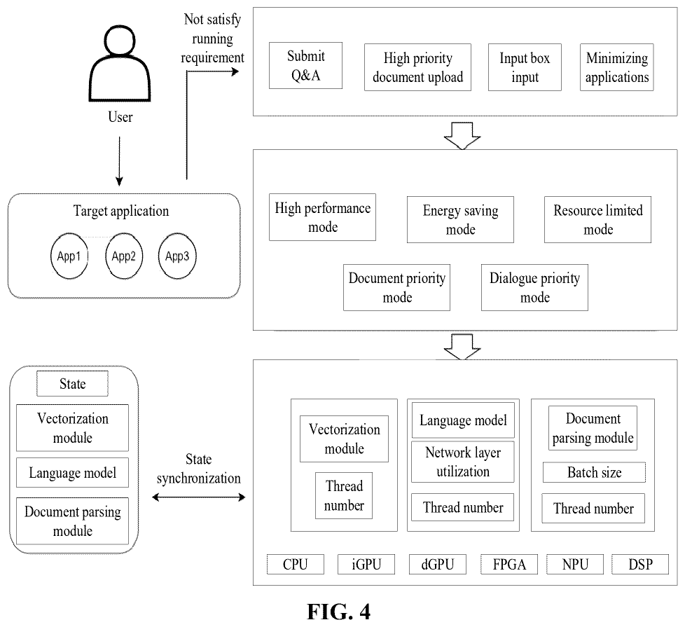

Taking FIG. 4 as an example, the user may operate the target applications, such as App1, App2 and App3, and the system may monitor the dynamic running information of the target applications. In response to determination that utilization of at least one type of resource by the target application does not fail to satisfy the running requirement based on the dynamic running information of the target application, there is no need to adjust utilization of at least one type of resource by the target model. At this point, current scheduling mode may be maintained. In response to determination that utilization of at least one type of resource by the target application does not satisfy the running requirement based on the dynamic running information of the target application, corresponding scheduling mode may need to be determined under different user intentions based on that utilization of at least one type of resource by the target application does not satisfy the running requirement.

The user intention may be determined based on the interaction information between the user and the target model. The interaction information may be, for example, submit a Q&A, high priority document upload, input box input, minimizing applications and the like. The user intention may be determined based on the interaction information. Exemplarily, in response to the interactive information being “submit a Q&A”, the user intention may be determined to be the dialogue intention; in response to the interaction information being “input box input”, the user intention may be determined to be the dialogue intention; in response to the interaction information being “high priority document upload”, the user intention may be determined to be the document operation intention; and in response to the interaction information being “minimizing applications”, the user intention may be determined to be no intention.

Furthermore, after determining corresponding scheduling mode, utilization of at least one type of resource in the system by the target model may be adjusted based on the scheduling mode.

As shown in FIG. 4, in response to that the target model is a large language model (LLM), utilization of at least one type of resource in the system by LLM may be adjusted, and utilization of at least one type of resource in the system by the functional modules in LLM may also be adjusted. The functional modules in LLM may be vectorization module ME5s and document parsing module Document Parsing. For utilization of at least one type of resource in the system by LLM, utilization of the graphics processor GPU may be reduced by adjusting a network layer in LLM from utilizing the graphics processor GPU to the central processing unit CPU, that is, by adjusting utilization of the network layer. The resource utilization may also be reduced by reducing the number of threads. For utilization of at least one type of resource in the system by the vectorization module ME5s, resource utilization may be reduced by reducing the number of threads. For utilization of at least one type of resource in the system by the document parsing module Document Parsing, resource utilization may be reduced by reducing the batch size (the number of samples) selected for one training or by reducing the number of threads.

Adjusting utilization of the network layer may be that, based on the utilization information, utilization of the first-type resource of the system by at least one network layer of at least one target model may be adjusted to utilization of the second-type resource of the system (for example, utilization of the CPU may be adjusted to utilization of the NPU); or, based on the utilization information, utilization of the first-type resource of the system by at least one network layer of at least one target model may be released. At least one type of resource of the system may be a central processing unit (CPU), an integrated graphics processing unit (iGPU), a discrete graphics processing unit (dGPU), a field-programmable gate array (FPGA), an embedded neural network processor (NPU), a digital signal processor (DSP) or the like.

For example, before adjusting utilization of at least one type of resource by the target model based on the scheduling mode, all network layers in the target model may utilize the first-type resource. After determining the scheduling mode and also determining the utilization information based on the scheduling mode, the 10th to 20th network layers in the target model may be controlled to utilize the second-type resource based on the utilization information, while the other network layers of the target model may still utilize the first-type resource. That is, utilization of the first-type resource by at least one network layer of the target model may be adjusted to utilization of the second-type resource; or utilization of the first-type resource by all network layers in the target model may be directly released.

The determination of the network layer may be determination of the network layer that can adjust the resource utilization based on actual current running state of the target model. Furthermore, after adjusting utilization of at least one type of resource in the

system by at least one target model running in the system based on the scheduling mode, the method may also include comparing whether utilization of at least one type of resource in the system by at least one target model after adjustment matches the utilization information of the resource corresponding to the scheduling mode. In response to determination that utilization of at least one type of resource in the system by at least one target model after adjustment does not match the utilization information of the resource corresponding to the scheduling mode, utilization of at least one type of resource in the system by at least one target model after adjustment may continue to be adjusted based on the scheduling mode until matching is determined.

That is, after adjusting utilization of at least one type of resource in the system by the target model based on the scheduling mode, the utilization information of at least one type of resource by the target model after adjustment may be determined. For example, actual utilization information of at least one type of resource by LLM may be outputted; actual utilization information of at least one type of resource by the vectorization module ME5s may be outputted, and actual utilization information of at least one type of resource by the document parsing module Document Parsing may be outputted. That is, the state synchronization of the target model may be performed. Furthermore, actual utilization information may be compared with the utilization information of corresponding resources in the scheduling mode. In response to determination that actual utilization information matches the resource utilization information in the scheduling mode, no further adjustment may be needed. In response to determination that actual utilization information does not match the resource utilization information in the scheduling mode, current utilization of at least one type of resource by the target model may need to be adjusted based on the scheduling mode until actual utilization information matches the resource utilization information in the scheduling mode, thereby ensuring that actual utilization of at least one type of resource by the target model matches the scheduling mode.

In addition, in the resource scheduling method provided in one embodiment, the target application may be first determined from the applications. The determination of the target application may be the following. Data interaction information of the application running in the system may be determined, and the application may be determined as the target application based on the data interaction information satisfies a threshold. For example, the application frequency of the application may be relatively high, or active duration of the window interface of the application may be relatively long, or the application may generate relatively large amount of interaction data. Or in response to the application running in the system and determination that the application belongs to a target application list, the application may be determined as the target application. That is, the target application list may be set first. The target application list may be the priority application list. As long as a certain application running in the system is determined to belong to the target application list, the application may be determined as the target application, and resources may be scheduled based on the resource scheduling method provided in one embodiment.

A resource scheduling method is provided in one embodiment. According to obtained dynamic running information of the target application in the system and the user intention, the scheduling mode corresponding to the system may be determined. The user intention may be determined based on the interaction information between the user and the target model. The scheduling mode may at least include one of the high-performance mode, the energy saving mode, the dialogue priority mode, the document priority mode and the resource limited mode. Based on the scheduling mode, utilization of at least one type of resource in the system by at least one target model running in the system may be adjusted, such that a corresponding type of resource needed to run the target application may be adjusted. For the solution provided in the present disclosure, the scheduling mode may be determined based on the dynamic running information of the target application and the user intention, and the user intention may be determined based on the interaction information between the user and the target model, thereby ensuring that utilization of at least one type of resource in the system by the target model after adjustment may satisfy the user intention.

Furthermore, the resource scheduling method provided in one embodiment may also include that according to passive running information of the target application in the system, utilization of at least one type of resource in the system by at least one target model running in the system may be adjusted based on the target scheduling mode, where the passive running information may at least include one of the stop of the target application and the reduction of the priority of the target application.

When the target application is running, the corresponding scheduling mode may be determined according to dynamic running information of the target application, and utilization of at least one type of resource by at least one target model running in the system may be adjusted based on the scheduling mode. In response to the target application switching from the running state to the stopped state, there may be no need to maintain current scheduling mode, which may be adjusted to the target scheduling mode.

The target scheduling mode may be the scheduling mode corresponding to the system before the running of the target application or may be a scheduling mode determined based on the dynamic running information of other target applications in the system after the target application stops or may be directly adjusted to the high-performance mode to ensure efficient running of the target model.

In addition to the stop of the target application, the passive running information of the target application may also include the reduction of the priority of the target application.

When the target application is in the target application list, it indicates that the target application may be a high-priority application. At this point, the scheduling mode may be adjusted based on the dynamic running information of the target application, such that utilization of at least one type of resource in the system by the target model may be adjusted, and corresponding type of resource needed for running the target application may be adjusted, thereby ensuring normal running of the target application. After the target application list is updated, the scheduling mode may need to be determined based on the dynamic running information of the target application running in updated target application list. In response to that the priority of the target application is reduced and no longer a high-priority application, the scheduling mode determined based on the target application may be adjusted to the target scheduling mode. The target scheduling mode may be a scheduling mode determined based on current high-priority application or may be the high-performance mode.

For the resource scheduling method provided in one embodiment, corresponding scheduling mode may be determined based on the dynamic running information or passive running information of the target application. In such way, utilization of at least one type of resource in the system by the target model may be adjusted, the adjustment of corresponding type of resource needed to run the target application may be realized, which may avoid abnormal running or inefficiency of the target application due to the target model excessively utilizing corresponding type of resource needed to run the target application. Meanwhile, the scheduling mode may be adjusted based on the passive running information of the target application, which may avoid utilization of resources by non-high priority applications.

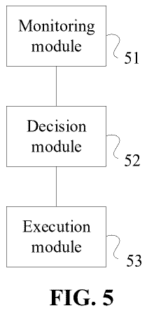

A resource scheduling apparatus is provided in one embodiment. The structural diagram of the resource scheduling apparatus is illustrated in FIG. 5. The resource scheduling apparatus may include a monitoring module 51, a decision module 52 and an execution module 53.

The monitoring module 51 may be configured to obtain the dynamic running information of the target application in the system; and the dynamic running information of the target application may at least include one of the running information and the resource utilization information of the target application.

The decision module 52 may be configured to determine the scheduling mode corresponding to the system at least according to obtained dynamic running information of the target application in the system; and the scheduling mode may characterize the utilization strategy of the target model for multiple types of resources in the system.

The execution module 53 may be configured to adjust utilization of at least one type of resource in the system by at least one target model running in the system based on the scheduling mode, such that corresponding type of resource needed to run the target application may be adjusted.

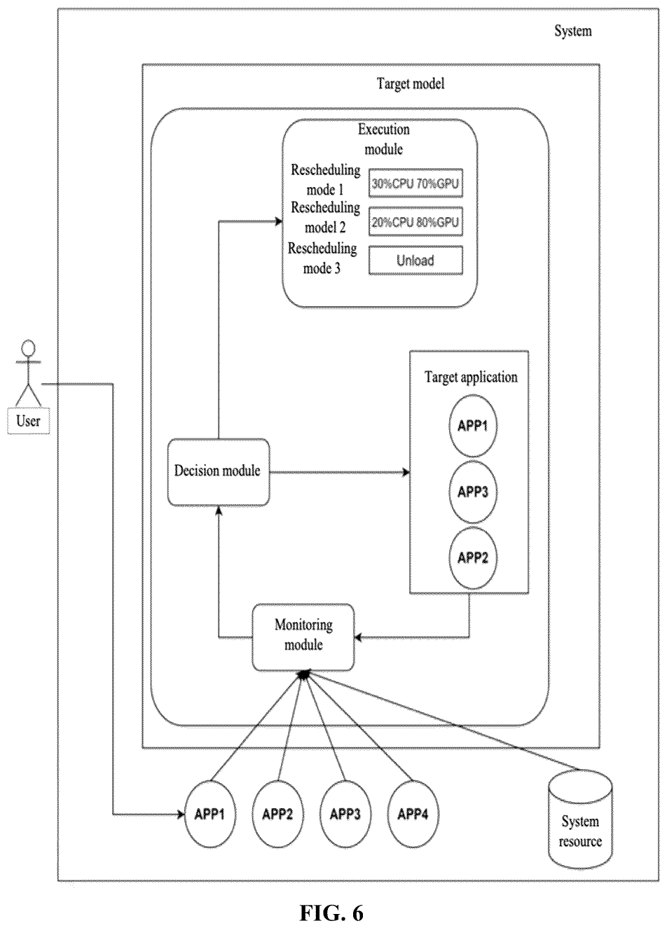

Furthermore, the resource scheduling apparatus provided in one embodiment is illustrated in FIG. 6 and may include the monitoring module, the decision module, and the execution module. The monitoring module may obtain the dynamic running information of the target application. The monitoring module may also obtain the resource utilization of different applications in the system. The decision module may determine the scheduling mode based on the information of the monitoring module. The execution module may, based on the scheduling mode, adjust utilization of different types of resources in the system by the target model.

Furthermore, the decision module may be configured to, in response to the system being currently in the first adjustment strategy and obtained resource utilization information of the target application in the system, determine whether utilization of at least one type of resource by the target application satisfies the running requirement; and in response to determining that utilization of at least one type of resource by the target application does not satisfy the running requirement, determine the scheduling mode corresponding to the system based on the running requirement.

Furthermore, the decision module may be configured to, in response to the system being currently in the second adjustment strategy and obtained running information of the target application in the system, determine the scheduling mode in the historical record corresponding to the target application; and determine the scheduling mode in the historical record corresponding to the target application as the scheduling mode corresponding to the system.

Furthermore, the decision module may be configured to, according to obtained dynamic running information of the target application in the system and the user intention, determine the scheduling mode corresponding to the system. The user intention may be determined based on the interaction information between the user and the target model. The scheduling mode may at least include one of the high-performance mode, the energy saving mode, the dialogue priority mode, the document priority mode and the resource limited mode. Utilization of at least one type of resource in the system by the target model in the high-performance mode may be greater than utilization of at least one type of resource in the system by the target model in in dialogue priority mode; utilization of at least one type of resource in the system by the target model in the in dialogue priority mode may be greater than utilization of at least one type of resource in the system by the target model in the document priority mode; utilization of at least one type of resource in the system by the target model in the in document priority mode may be greater than utilization of at least one type of resource in the system by the target model in the energy saving mode; and in the resource limited mode, utilization of at least one type of resource in the system by the target model may depend on limiting parameters.

Furthermore, the decision module may be configured to, in response to the user intention being the dialogue intention and determination that utilization of at least one type of resource by the target application does not satisfy the running requirement, at least determine the scheduling mode corresponding to the system to be the high-performance mode, the dialogue priority mode, or the resource limited mode; in response to the user intention being the document operation intention and determination that utilization of at least one type of resource by the target application does not satisfy the running requirement, at least determine the scheduling mode corresponding to the system to be the document priority mode, the resource limited mode, or the energy saving mode; and in response to the user intention being no intention and determination that utilization of at least one type of resource by the target application does not satisfy the running requirement, at least determine the scheduling mode corresponding to the system to be the energy saving mode.

Furthermore, the decision module may be configured to, based on the scheduling mode, determine the utilization information of at least one type of resource needed to run at least one target model; the utilization information may include whether at least one type of resource is utilized and the resource utilization size; and utilization of at least one type of resource by at least one target model may be adjusted based on the utilization information.

Furthermore, the decision module may be configured to, based on the utilization information, adjust utilization of the first-type resource by at least one network layer of the target model to utilization of the second-type resource; or based on the utilization information, directly release utilization of the first-type resource by at least one network layer of the target model.

Furthermore, the decision module may be configured to, according to passive running information of the target application in the system, adjust utilization of at least one type of resource in the system by at least one target model running in the system based on the target scheduling mode, where the passive running information may at least include one of the stopping of the target application and the priority reduction of the target application.

Furthermore, the decision module may be configured to, based on the scheduling mode, adjust utilization of at least one type of resource in the system by at least one target model running in the system; compare whether utilization of at least one type of resource in the system by at least one target model after adjustment matches the utilization information of the resource corresponding to the scheduling mode; in response to determination that utilization of at least one type of resource in the system by at least one target model after adjustment does not match the utilization information of the resource corresponding to the scheduling mode, continue to adjust utilization of at least one type of resource in the system by at least one target model after adjustment based on the scheduling mode until matching is determined.

The resource scheduling apparatus provided in one embodiment may be implemented based on the resource scheduling method disclosed in above-mentioned embodiments, which may not be described in detail herein.

For the resource scheduling apparatus provided in the present disclosure, the scheduling mode corresponding to the system may be determined at least according to obtained dynamic running information of the target application in the system, where the dynamic running information of the target application may at least include one of the running information and the resource utilization information of the target application, and the scheduling mode may characterize the utilization strategy of the target model for multiple types of resources in the system; and based on the scheduling mode, utilization of at least one type of resource in the system by at least one target model running in the system may be adjusted, such that corresponding type of resource needed to run the target application may be adjusted. For the solution provided in the present disclosure, the scheduling mode corresponding to the system may be determined at least according to obtained running information or resource utilization information of the target application in the system and may adjust utilization of at least one type of resource in the system by the target model based on corresponding scheduling mode. Therefore, adjustment of corresponding type of resource needed to run the target application may be realized, which may avoid abnormal running or inefficiency of the target application due to the target model excessively utilizing corresponding type of resource needed to run the target application.

Compared with the existing technology, the technical solutions provided by the present disclosure may achieve at least the following beneficial effects.

As disclosed above, the scheduling mode corresponding to the system may be determined at least according to obtained dynamic running information of the target application in the system, where the dynamic running information of the target application may at least include one of the running information and the resource utilization information of the target application, and the scheduling mode may characterize the utilization strategy of the target model for multiple types of resources in the system; and based on the scheduling mode, utilization of at least one type of resource in the system by at least one target model running in the system may be adjusted, such that corresponding type of resource needed to run the target application may be adjusted. For the solution provided in the present disclosure, the scheduling mode corresponding to the system may be determined at least according to obtained running information or resource utilization information of the target application in the system and may adjust utilization of at least one type of resource in the system by the target model based on corresponding scheduling mode. Therefore, adjustment of corresponding type of resource needed to run the target application may be realized, which may avoid abnormal running or inefficiency of the target application due to the target model excessively utilizing corresponding type of resource needed to run the target application.

In the present disclosure, each embodiment is described in a progressive manner. Each embodiment focuses on the differences from other embodiments. Same and similar parts between embodiments may be referred to each other. The apparatus disclosed in embodiments of the present disclosure may correspond to the method disclosed in embodiments of the present disclosure, and the description of the apparatus may be relatively simple, which may refer to the description of the method disclosed in embodiments the present disclosure.

Those skilled in the art may further understand that exemplary units and algorithm steps described in embodiments of the present disclosure may be implemented by electronic hardware, computer software, or a combination thereof. In order to clearly illustrate the interchangeability of hardware and software, the composition and steps of each embodiment may have been described in above description according to the functions. Whether these functions are performed in hardware or software may depend on application and design constraints of the technical solution. Those skilled in the art may use different methods to implement described functions for each application, but such implementation should not be considered to be beyond the scope of the present disclosure.

The steps of the method or algorithm described in embodiments of the present disclosure may be implemented directly using hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known to those skilled in the art.

Above description of disclosed embodiments may enable those skilled in the art to implement or use the present disclosure. Various modifications to above-mentioned embodiments may be apparent to those skilled in the art. Principles defined in the present disclosure may be implemented in other embodiments without departing from the spirit or scope of the present disclosure. Therefore, the present disclosure may not be limited to the embodiments of the present disclosure but may conform to the widest scope consistent with the principles and novel features disclosed in the present disclosure.

What is claimed is:

1. A resource scheduling method, comprising:
determining a scheduling mode corresponding to a system at least according to dynamic running information of a target application in the system, wherein the dynamic running information of the target application at least includes one of running information and resource utilization information of the target application; and the scheduling mode characterizes a utilization strategy of a target model for multiple types of resources in the system; and
based on the scheduling mode, adjusting utilization of at least one type of resource in the system by at least one target model running in the system, such that a corresponding type of resource needed to run the target application is adjusted.

2. The method according to claim 1, wherein determining the scheduling mode corresponding to the system at least according to the dynamic running information of the target application in the system includes:
in response to the system being currently in a first adjustment strategy and the resource utilization information of the target application in the system, determining whether the utilization of the at least one type of resource by the target application satisfies a running requirement; and
in response to a determination that the utilization of the at least one type of resource by the target application does not satisfy the running requirement, determining the scheduling mode corresponding to the system based on the running requirement.

3. The method according to claim 1, wherein determining the scheduling mode corresponding to the system at least according to the dynamic running information of the target application in the system includes:
in response to the system being currently in a second adjustment strategy and the running information of the target application in the system, determining a scheduling mode corresponding to the target application in a historical record; and
determining the scheduling mode corresponding to the target application in the historical record as the scheduling mode corresponding to the system.

4. The method according to claim 1, wherein determining the scheduling mode corresponding to the system at least according to the dynamic running information of the target application in the system includes:
according to user intention and the dynamic running information of the target application in the system, determining the scheduling mode corresponding to the system, wherein:
the user intention is determined based on interaction information between a user and the target model;
the scheduling mode at least includes one of a high-performance mode, an energy saving mode, a dialogue priority mode, a document priority mode and a resource limited mode;
the utilization of the at least one type of resource by the target model in the high-performance mode is greater than the utilization of the at least one type of resource by the target model in the dialogue priority mode; the utilization of the at least one type of resource by the target model in the dialogue priority mode is greater than the utilization of the at least one type of resource by the target model in the document priority mode; the utilization of the at least one type of resource by the target model in the document priority mode is greater than the utilization of the at least one type of resource by the target model in the energy saving mode; and the utilization of the at least one type of resource by the target model in the resource limited mode depends on a limiting parameter.

5. The method according to claim 4, wherein according to the user intention and the dynamic running information of the target application in the system, determining the scheduling mode corresponding to the system includes:
in response to the user intention being a dialogue intention and a determination that the utilization of the at least one type of resource by the target application does not satisfy the running requirement, at least determining the scheduling mode corresponding to the system to be the high-performance mode, the dialogue priority mode, or the resource limited mode;
in response to the user intention being a document operation intention and the determination that the utilization of the at least one type of resource by the target application does not satisfy the running requirement, at least determining the scheduling mode corresponding to the system to be the document priority mode, the resource limited mode, or the energy saving mode; and
in response to the user intention being no intention and the determination that the utilization of the at least one type of resource by the target application does not satisfy the running requirement, at least determining the scheduling mode corresponding to the system to be the energy saving mode.

6. The method according to claim 1, wherein based on the scheduling mode, adjusting the utilization of the at least one type of resource in the system by the at least one target model running in the system includes:
based on the scheduling mode, determining utilization information of the at least one type of resource needed to run the at least one target model, wherein the utilization information includes a resource utilization size and whether the at least one type of resource is utilized; and
based on the utilization information, adjusting the utilization of the at least one type of resource by the at least one target model.

7. The method according to claim 6, wherein based on the utilization information, adjusting the utilization of the at least one type of resource by the at least one target model includes:
based on the utilization information, adjusting utilization of a first-type resource by the at least one network layer of the at least one target model to utilization of a second-type resource by the at least one network layer of the at least one target model; or
based on the utilization information, releasing utilization of the first-type resource by the at least one network layer of the at least one target model.

8. The method according to claim 1, further including:
according to passive running information of the target application in the system, adjusting the utilization of the at least one type of resource in the system by the at least one target model running in the system based on the target scheduling mode, wherein the passive running information at least includes one of stopping the target application and priority reduction of the target application.

9. The method according to claim 1, wherein based on the scheduling mode, adjusting the utilization of the at least one type of resource in the system by the at least one target model running in the system includes:
comparing whether the utilization of the at least one type of resource in the system by the at least one target model after adjustment matches resource utilization information corresponding to the scheduling mode; and
in response to a determination that the utilization of the at least one type of resource in the system by the at least one target model after adjustment does not match the resource utilization information corresponding to the scheduling mode, continuing to adjust the utilization of the at least one type of resource in the system by the at least one target model after adjustment based on the scheduling mode until a match between the utilization of the at least one type of resource in the system by the at least one target model after adjustment and the resource utilization information corresponding to the scheduling mode is determined.

10. A computing system, comprising:
a memory, configured to store a computer program; and
one or more processors, configured to, when the computer program is executed, perform a resource scheduling method by performing:
determining a scheduling mode corresponding to a system at least according to dynamic running information of a target application in the system, wherein the dynamic running information of the target application at least includes one of running information and resource utilization information of the target application; and the scheduling mode characterizes a utilization strategy of a target model for multiple types of resources in the system; and
based on the scheduling mode, adjusting utilization of at least one type of resource in the system by at least one target model running in the system, such that a corresponding type of resource needed to run the target application is adjusted.

11. The system according to claim 10, wherein for determining the scheduling mode corresponding to the system at least according to the dynamic running information of the target application in the system, the one or more processors are configured to:
in response to the system being currently in a first adjustment strategy and the resource utilization information of the target application in the system, determine whether the utilization of the at least one type of resource by the target application satisfies a running requirement; and
in response to a determination that the utilization of the at least one type of resource by the target application does not satisfy the running requirement, determine the scheduling mode corresponding to the system based on the running requirement.

12. The system according to claim 10, wherein for determining the scheduling mode corresponding to the system at least according to the dynamic running information of the target application in the system, the one or more processors are configured to:
in response to the system being currently in a second adjustment strategy and the running information of the target application in the system, determine a scheduling mode corresponding to the target application in a historical record; and
determine the scheduling mode corresponding to the target application in the historical record as the scheduling mode corresponding to the system.

13. The system according to claim 10, wherein for determining the scheduling mode corresponding to the system at least according to the dynamic running information of the target application in the system, the one or more processors are configured to:
according to user intention and the dynamic running information of the target application in the system, determine the scheduling mode corresponding to the system, wherein:
the user intention is determined based on interaction information between a user and the target model;
the scheduling mode at least includes one of a high-performance mode, an energy saving mode, a dialogue priority mode, a document priority mode and a resource limited mode;
the utilization of the at least one type of resource by the target model in the high-performance mode is greater than the utilization of the at least one type of resource by the target model in the dialogue priority mode; the utilization of the at least one type of resource by the target model in the dialogue priority mode is greater than the utilization of the at least one type of resource by the target model in the document priority mode; the utilization of the at least one type of resource by the target model in the document priority mode is greater than the utilization of the at least one type of resource by the target model in the energy saving mode; and the utilization of the at least one type of resource by the target model in the resource limited mode depends on a limiting parameter.

14. The system according to claim 13, wherein for determining the scheduling mode corresponding to the system according to the user intention and the dynamic running information of the target application in the system, the one or more processors are configured to:
in response to the user intention being a dialogue intention and a determination that the utilization of the at least one type of resource by the target application does not satisfy the running requirement, at least determine the scheduling mode corresponding to the system to be the high-performance mode, the dialogue priority mode, or the resource limited mode;
in response to the user intention being a document operation intention and the determination that the utilization of the at least one type of resource by the target application does not satisfy the running requirement, at least determine the scheduling mode corresponding to the system to be the document priority mode, the resource limited mode, or the energy saving mode; and
in response to the user intention being no intention and the determination that the utilization of the at least one type of resource by the target application does not satisfy the running requirement, at least determine the scheduling mode corresponding to the system to be the energy saving mode.

15. The system according to claim 10, wherein for adjusting the utilization of the at least one type of resource in the system by the at least one target model running in the system based on the scheduling mode, the one or more processors are configured to:
based on the scheduling mode, determine utilization information of the at least one type of resource needed to run the at least one target model, wherein the utilization information includes a resource utilization size and whether the at least one type of resource is utilized; and
based on the utilization information, adjust the utilization of the at least one type of resource by the at least one target model.

16. The system according to claim 15, wherein for adjusting the utilization of the at least one type of resource by the at least one target model based on the utilization information, the one or more processors are configured to:
based on the utilization information, adjust utilization of a first-type resource by the at least one network layer of the at least one target model to utilization of a second-type resource by the at least one network layer of the at least one target model; or
based on the utilization information, release utilization of the first-type resource by the at least one network layer of the at least one target model.

17. The system according to claim 10, wherein the one or more processors are further configured to:
according to passive running information of the target application in the system, adjust the utilization of the at least one type of resource in the system by the at least one target model running in the system based on the target scheduling mode, wherein the passive running information at least includes one of stopping the target application and priority reduction of the target application.

18. The system according to claim 10, wherein for adjusting the utilization of the at least one type of resource in the system by the at least one target model running in the system based on the scheduling mode, the one or more processors are configured to:
based on the scheduling mode, adjust the utilization of the at least one type of resource in the system by the at least one target model running in the system;
compare whether the utilization of the at least one type of resource in the system by the at least one target model after adjustment matches resource utilization information corresponding to the scheduling mode; and
in response to a determination that the utilization of the at least one type of resource in the system by the at least one target model after adjustment does not match the resource utilization information corresponding to the scheduling mode, continue to adjust the utilization of the at least one type of resource in the system by the at least one target model after adjustment based on the scheduling mode until a match between the utilization of the at least one type of resource in the system by the at least one target model after adjustment and the resource utilization information corresponding to the scheduling mode is determined.

19. A non-transitory computer-readable storage medium, containing a computer program that when being executed, causes at least one processor to perform:
determining a scheduling mode corresponding to a system at least according to dynamic running information of a target application in the system, wherein the dynamic running information of the target application at least includes one of running information and resource utilization information of the target application; and the scheduling mode characterizes a utilization strategy of a target model for multiple types of resources in the system; and
based on the scheduling mode, adjusting utilization of at least one type of resource in the system by at least one target model running in the system, such that a corresponding type of resource needed to run the target application is adjusted.

20. The storage medium according to claim 19, wherein for determining the scheduling mode corresponding to the system at least according to the dynamic running information of the target application in the system, the at least one processor is configured to perform:
in response to the system being currently in a first adjustment strategy and the resource utilization information of the target application in the system, determining whether the utilization of the at least one type of resource by the target application satisfies a running requirement; and
in response to a determination that the utilization of the at least one type of resource by the target application does not satisfy the running requirement, determining the scheduling mode corresponding to the system based on the running requirement.
